(19) United States
(12) Patent Application Publication
(10) Pub. No.: US 2009/0183437 A1
(43) Pub. Date: Jul. 23, 2009

(54) JOINING SYSTEM FOR METAL DOOR FRAMES

(75) Inventor: Chun-Ming CHEN, Salter Point (AU)

Correspondence Address: NIXON & VANDERHYE, PC, 901 NORTH GLEBE ROAD, 11TH FLOOR, ARLINGTON, VA, 22203, US

(73) Assignee: JDS METAL DOORFRAME MANUFACTURE PTY. LTD., Maddington (AU)

(21) Appl. No.: 12/056,657

(22) Filed: Mar. 27, 2008

(30) Foreign Application Priority Data
Jan. 18, 2008 (AU) 2008100058

(51) Int. Cl. E06B 1/04

(52) U.S. Cl. 49/504

(57) ABSTRACT

The 3-piece metal door frame comprises two vertical side metal door frame members and a horizontal top metal door frame member. An improved joining system comprises a pair of L-shaped joining brackets provided on one of the door frame members, the joining brackets being adapted to receive matching screw fasteners provided in connection with an adjoining door frame member. When the screws are received in the brackets they allow the adjoining frame members to achieve a secure and close mitre fit. Guiding tabs are provided at the top of the jam of each vertical side door frame member and are adapted to be received in matching slots provided in each end of the jam of the horizontal top metal door frame member. When two of the door frame members are joined to form a joint the guiding tabs help to keep the door frame members correctly aligned.

### FIELD OF THE INVENTION

The present invention relates to an improved system for joining metal door frame members and also to a metal door frame incorporating the improved joining system.

### BACKGROUND TO THE INVENTION

Frames for doors and windows have traditionally been made from wood and frequently included quite ornate architraves (the moulded frame visible around a doorway or window). In more recent times metal door frames have replaced the traditional wooden door frames and window frames in many houses and buildings, especially those with brick walls. Metal door frames can be more readily standardised and mass produced, and can be quickly installed by builders. However, aesthetically such metal door frames have few attractive features, being designed primarily with functional considerations in mind. The architraves are generally plain rectangular metal sections, similar in size and shape to the door jamb itself.

Commonly owned Australian Innovation Patent No 2005100459 discloses an improved metal door frame comprising two vertical side metal door frame members and a horizontal top metal door frame member. Each door frame member is folded to provide a door jamb facing inwards and having a skirt that extends outwards on both sides of the door jamb for attaching the door frame to a wall. A distinguishing feature of the door frame of AU2005100459 is the cross-sectional shape of each door frame member which includes a wave portion extending between the door jamb and the skirt.

Each vertical door frame member of the door frame of AU2005100459 is joined to the horizontal top door frame member by a plurality of connecting tabs received in matching slots cut into the adjoining member. In the preferred embodiment the tabs are provided on the vertical side door frame members, and the slots are provided in the horizontal top door frame member (see FIG. 4). Advantageously three tabs are provided on the door jamb portion of the metal section, one tab on the protruding part of the door jamb portion and two tabs either side of the protruding part.

In order to join the door frame members together, the connecting tabs are inserted into the matching slots of the adjoining door frame member and then hammered down flat so as to grip the adjoining member.

This type of 3-piece knock down door frame is mainly used for stud walls and sometimes for masonry walls. In either situation, because of imperfections of the door opening in the wall, there are often problems fitting the door frame especially associated with mitre joints. One of the problems with this type of prior art joining system is that if the connecting tabs are not hammered down properly, the mitre joint will not form correctly and gaps will appear. In addition the tab down system does not permit fine tuning of the joint to ensure a better mitre fit.

The present invention was developed with a view to providing an improved joining system for metal door frames that permits a closer fit to be achieved between adjoining door frame members.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided an improved joining system for metal door frames of the type having two vertical side metal door frame members and a horizontal top metal door frame member, the improved joining system comprising:

a joining bracket provided on one of the door frame members, the joining bracket being adapted to receive a fastener provided in connection with an adjoining door frame member;

a guiding tab provided on one of the door frame members, the guiding tab being adapted to be received in a matching slot provided in an adjoining door frame member, wherein when two of the door frame members are joined to form a joint the guiding tab helps to keep the door frame members correctly aligned and the fastener received in the bracket allows the adjoining frame members to achieve a close fit.

According to another aspect of the present invention there is provided a metal door frame incorporating an improved joining system, the metal door frame comprising:

two vertical side metal door frame members and a horizontal top metal door frame member;

a joining bracket provided on one of the door frame members, the joining bracket being adapted to receive a fastener provided in connection with an adjoining door frame member;

a guiding tab provided on one of the door frame members, the guiding tab being adapted to be received in a matching slot provided in an adjoining door frame member, wherein when two of the door frame members are joined to form a joint the guiding tab helps to keep the door frame members correctly aligned and the fastener received in the bracket allows the adjoining frame members to achieve a close fit.

Typically the door frame members are joined to form a mitre joint. Preferably the bracket is one of a pair of brackets provided on one of the door frame members, one bracket being provided at the front of and the other being provided at the rear of the door frame member. Preferably each bracket has a threaded aperture provided therein and the fasteners provided in connection with the adjoining door frame are threaded screws adapted to engage with the threaded aperture in the respective brackets. Typically the adjoining door frame member has a pair of apertures provided therein through which the respective screws are received, each aperture being countersunk to receive a head of a respective screw in a flush fit.

Preferably the brackets are provided on the vertical side door frame members and the countersunk apertures are provided in the horizontal top metal door frame member. Preferably the guiding tab is one of a pair of guiding tabs provided on each vertical side door frame member and matching slots are provided in the horizontal top metal door frame member.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of preferred embodiments of the improved joining system for metal door frames, given by way of example only, with reference to the accompanying drawings, in which:

FIG. 1 (a) illustrates a first embodiment of the improved joining system for metal door frames according to the present invention;

FIG. 1 (b) is an enlargement of the improved joining system for metal door frames of FIG. 1 (a);

FIG. 2 (a) illustrates a second embodiment of the improved joining system for metal door frames according to the present invention;

FIG. 2 (b) is an enlargement of one part of the improved joining system for metal door frames of FIG. 2 (a); and,

FIG. 2 (c) is an enlargement of another part of the improved joining system for metal door frames of FIG. 2 (a).

### DETAILED DESCRIPTION OF PREFERRED EMBODIMENTS

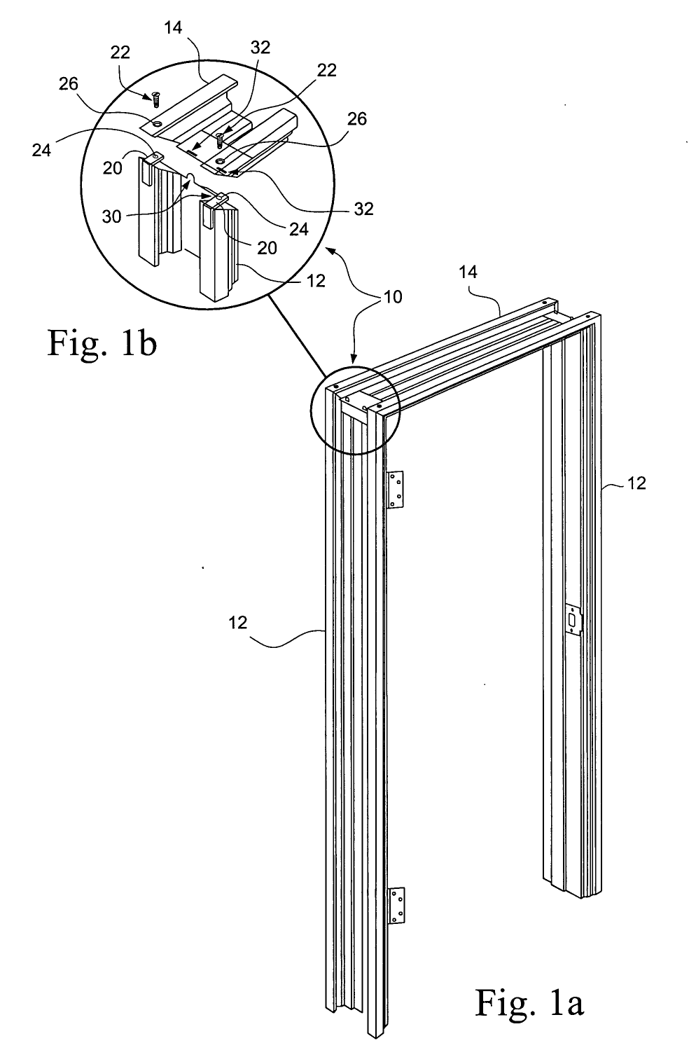

FIG. 1 illustrates a 3-piece knock down metal door frame, similar to that described in AU2005100459, which incorporates a first embodiment of the improved joining system 10 of the present invention. The 3-piece metal door frame comprises two vertical side metal door frame members 12 and a horizontal top metal door frame member 14. This type of 3-piece knock down frame is widely used for stud walls due to the construction method used and for buildings in remote locations because of the ease of transportation compared to welded frames. The improved joining system of the present invention simplifies the installation process and can achieve a better fit, especially with a mitre joint as in the illustrated embodiment.

In the improved joining system 10 a pair of L-shaped joining brackets 20 is provided on one of the door frame members, the joining brackets 20 being adapted to receive matching fasteners provided in connection with an adjoining door frame member as can be seen most clearly in FIG. 1(b). In this embodiment the joining brackets 10 are provided on the two vertical side metal door frame members 12 and fasteners 22 are provided in connection with the horizontal top metal door frame member 14. One of the joining brackets 20 is provided adjacent a front edge of each door frame member 12 and the other is provided adjacent a rear edge of the door frame member 12.

Each L-shaped joining bracket 20 preferably has a threaded aperture 24 provided therein, and the fasteners provided in connection with the adjoining top door frame member 14 are threaded screws 22 adapted to engage with the threaded apertures 24 in the respective brackets 20. Typically the adjoining top door frame member 14 has a pair of apertures 26 provided therein through which the respective screws 22 are received. Each of the apertures 26 is preferably countersunk to receive a head of a respective screw 22 therein with a flush fit as shown in FIG. 1(a). When the screws 22 are received in the brackets 20 they allow the adjoining frame members to achieve a secure and close fit. The threaded screw apertures 24 on the joining brackets 20 allow fine tuning of the join to create a mitre joint close to that of a fully welded frame.

A pair of guiding tabs 30 is provided on one of the door frame members. The guiding tabs 30 are adapted to be received in matching slots 32 provided in an adjoining door frame member. In this embodiment the guiding tabs 30 are provided at the top of the jam of each vertical side door frame member 12 and matching slots 32 are provided in each end of the jam of the horizontal top metal door frame member 14. When two of the door frame members are joined to form a joint the guiding tabs 30 help to keep the door frame members correctly aligned.

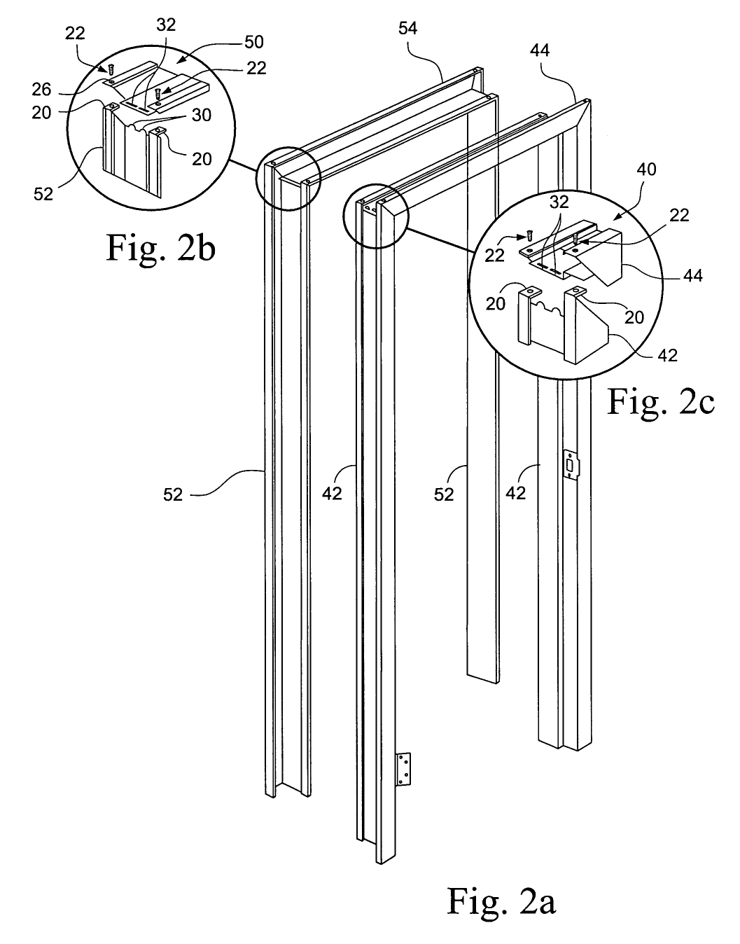

FIG. 2 illustrates a typical 6-piece knock down split door frame which incorporates a second embodiment of the joining system according to the present invention. The joining system of this embodiment is in two parts, one for the front frame and the other for the rear frame of the split door frame. The front door frame comprises two vertical side metal door frame members 42 and a horizontal top metal door frame member 44. The rear door frame comprises two vertical side metal door frame members 52 and a horizontal top metal door frame member 54. The joining system 50 for the rear door frame and the joining system 40 for the front door frame are both very similar to the arrangement of the first embodiment 10, and therefore the same reference numerals are used in FIGS. 2(b) and 2(c) to refer to the similar parts as in FIG. 1(b).

In the split door frame the outer face of both the rear door frame and the front door frame is larger than the inner face. This is the visible face of the door frame which forms the architrave on both sides of the doorway. Hence in this embodiment one of the L-shaped brackets 20, in each of the joining systems 40 and 50, is provided at a different height relative to its pair to accommodate the difference in size of the inner and outer faces of the respective frame members. In other respects the joining systems 40 and 50 are substantially identical to the first embodiment 10 illustrated in FIG. 1.

Now that preferred embodiments of the improved joining system for metal door frames have been described in detail, it will be apparent that each of the described embodiments provide a number of advantages over the prior art, including the following:

It is easier to fit and does not require hammering down of tabs.

It allows a more accurate mitre joint to be achieved because the fitter is able to fine adjust the mitre area with the screw fasteners.

It provides a smooth finish. The countersunk apertures on the top of the frame hide the screw fasteners and make for a neater finish.

It can also be used for split system door frames.

It will be readily apparent to persons skilled in the relevant arts that various modifications and improvements may be made to the foregoing embodiments, in addition to those already described, without departing from the basic inventive concepts of the present invention. For example, the brackets need not be provided on the vertical side door frame members, nor do the guiding tabs need to be provided on the vertical side door frame members. They could just as readily have been provided on the horizontal top door frame member. Therefore, it will be appreciated that the scope of the invention is not limited to the specific embodiments described and is to be determined from the appended claims.

The claims defining the invention are as follows:

1. An improved joining system for metal door frames of the type having two vertical side metal door frame members and a horizontal top metal door frame member, the improved joining system comprising:
a joining bracket provided on one of the door frame members, the joining bracket being adapted to receive a fastener provided in connection with an adjoining door frame member;
a guiding tab provided on one of the door frame members, the guiding tab being adapted to be received in a matching slot provided in an adjoining door frame member, wherein when two of the door frame members are joined to form a joint the guiding tab helps to keep the door frame members correctly aligned and the fastener received in the bracket allows the adjoining frame members to achieve a close fit.

2. An improved joining system for metal door frames as defined in claim 1, wherein the door frame members are joined to form a mitre joint.

3. An improved joining system for metal door frames as defined in claim 1, wherein the bracket is one of a pair of brackets provided on one of the door frame members, one bracket being provided at the front of the door frame member and the other being provided at the rear of the door frame member.

4. An improved joining system for metal door frames as defined in claim 3, wherein each bracket has a threaded aperture provided therein and the fasteners provided in connection with the adjoining door frame are threaded screws adapted to engage with the threaded aperture in the respective brackets.

5. An improved joining system for metal door frames as defined in claim 4, wherein the adjoining door frame member has a pair of apertures provided therein through which the respective screws are received, each aperture being countersunk to receive a head of a respective screw in a flush fit.

6. An improved joining system for metal door frames as defined in claim 5, wherein the brackets are provided on the vertical side door frame members and the countersunk apertures are provided in the horizontal top metal door frame member.

7. An improved joining system for metal door frames as defined in claim 1, wherein the guiding tab is one of a pair of guiding tabs provided on each vertical side door frame member and matching slots are provided in the horizontal top metal door frame member.

8. A metal door frame incorporating an improved joining system, the metal door frame comprising:
two vertical side metal door frame members and a horizontal top metal door frame member;
a joining bracket provided on one of the door frame members, the joining bracket being adapted to receive a fastener provided in connection with an adjoining door frame member;
a guiding tab provided on one of the door frame members, the guiding tab being adapted to be received in a matching slot provided in an adjoining door frame member, wherein when two of the door frame members are joined to form a joint the guiding tab helps to keep the door frame members correctly aligned and the fastener received in the bracket allows the adjoining frame members to achieve a close fit.
